(19) United States
(12) Patent Application Publication
(10) Pub. No.: US 2010/0280836 A1
(43) Pub. Date: Nov. 4, 2010

(54) FIRST RESPONDER DECISION SUPPORT SYSTEM BASED ON BUILDING INFORMATION MODEL (BIM)

(76) Inventors: Yan Lu, West Windsor, NJ (US); George Lo, Plainsboro, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/754,276

(22) Filed: Apr. 5, 2010

Related U.S. Application Data
(60) Provisional application No. 61/166,350, filed on Apr. 3, 2009.

(51) Int. Cl. G06Q 90/00; G08B 21/00

(52) U.S. Cl. 705/1.1; 340/540

(57) ABSTRACT

A first responder support system is disclosed. The first responder support system includes a plurality of sensors deployed within a building, such that each of the plurality of sensors is configured to communicate an environmental condition, an emergency control module in communication with the plurality of sensors deployed within the building, the emergency control module is configured to receive the environmental conditions provide by the plurality of sensors, a modeling module configured to receive a building information model and to generate a building representation, and a responder support module in communication with the emergency control module and the modeling module and configured to generate an interactive rescue plan based on the building representation and the received environmental conditions.

### CROSS REFERENCE TO RELATED APPLICATIONS

This application claims the priority benefit provided under 35 U.S.C. §119(e) to U.S. provisional patent application Ser. No. 61/166,350, entitled FIRST RESPONDER DECISION SUPPORT SYSTEM BASED ON BUILDING INFORMATION MODEL (BIM) filed on Apr. 3, 2009 which is incorporated herein by reference in its entirety.

### TECHNICAL FIELD

This patent generally relates to an exemplary fire safety system, and specifically to a system for supporting and providing real-time information to a first responder.

### BACKGROUND

Postmortem analysis and investigation of emergency situations and responses invariably reveals that prior planning and emergency preparation can increase the effectiveness of the response. Accordingly building and/or site managers have been required by U.S. Department of Labor and Occupational Safety and Health Administration (OSHA) to establish an emergency action plan (EAP) for each individual building and site location under their supervision.

An exemplary emergency action plan (EAP) is a written document designed to facilitate and organize employer and employee actions during workplace emergencies. The EAP is required by OSHA standards and regulations specified by 29 C.F.R. §1910.38(a). A well-developed emergency action plan combined with proper employee training results in fewer and less severe casualties and less structural damage to the facility during an emergency.

A static EAP is an effective tool for planning a response that may be experience by most small buildings or sites. However, as the building and site complexity increases, the static EAP may be an insufficient resource for effectively responding to an emergency. It would be desirable to provide a more effective emergency action plan that may be utilized by both site managers and first responders in the event of an emergency.

### SUMMARY

The system, method and device disclosed herein provides for automatically generating a real-time emergency action plan accessible by first responders and site managers. The real-time action plan may provide a first responder with site and surrounding information necessary for efficiently deploying resources to address an emergency. The real-time action plan may include detailed information from a building information model, site and surrounding environment information, real-time traffic information, alarm and sensor information. The real-time action plan may further cooperate with a rescue plan generator to provide a first responder with the tools to plan an ingress and egress from a site undergoing an emergency.

In one embodiment, a first responder support system is disclosed. The first responder support system includes a plurality of sensors deployed within a building, wherein each of the plurality of sensors is configured to communicate an environmental condition, an emergency control module in communication with the plurality of sensors deployed within the building, wherein the emergency control module is configured to receive the environmental conditions provided by the plurality of sensors, a modeling module configured to receive a building information model and to generate a building representation, and a responder support module in communication with the emergency control module and the modeling module and configured to generate an interactive rescue plan based on the building representation and the received environmental conditions.

In another embodiment, a method for generating an interactive rescue plan is disclosed. The method includes deploying a plurality of sensors within a building at a first location, receiving a sensed environmental condition for at least one of the plurality of sensors, triggering an emergency alert in response to the received sensed environmental condition, communicating the received sensed environmental condition and a building information model to a second location, receiving the received sensed environmental condition and the building information model at a modeling module deployed at a second location, generating an interactive building representation based on the received sensed environmental condition and the building information model, and generating an interactive rescue plan based on the interactive building representation and one or more business rules.

In another embodiment, a first responder support device is disclosed. The device includes a communication module configured to receive at least one environmental condition from a plurality of sensors deployed within a building, wherein the building, wherein each of the plurality of sensors is configured to communicate an environmental condition, a modeling module configured to receive, via the communication module, a building information model and to generate a building representation, a responder support module in communication with the communication module and the modeling module and configured to generate an interactive rescue plan based on the building representation and the received environmental conditions, and an interface module configured to present the interactive rescue plan.

Other embodiments are disclosed, and each of the embodiments can be used alone or together in combination. Additional features and advantages of the disclosed embodiments are described in, and will be apparent from, the following Detailed Description and the figures.

### BRIEF DESCRIPTION OF THE FIGURES

The system, method and device may be better understood with reference to the following figures and associated detailed description. Non-limiting and non-exhaustive embodiments are described with reference to the provided figures. Individual components shown in the figures are not necessarily to scale, emphasis instead being placed upon illustrating the principles and features of the claimed system, method and device. In the figures, like reference numerals designate common and/or corresponding components referenced in different figures and views.

FIG. 1 illustrates an exemplary first responder support system configured according to the disclosure provided herein;

FIG. 2 illustrates an exemplary emergency site configured for operation within the first responder support system shown in FIG. 1;

FIG. 3 illustrates a first responder configured and prepared to utilize the first responder support system shown in FIG. 1;

FIG. 4 illustrates a mobile first responder device configured for operation within the first responder support system shown in FIG. 1;

FIG. 5 illustrates an exemplary logical layout for an exemplary responder support module

FIG. 6 illustrates an exemplary operational flowchart of a first responder support system according to the disclosure provided herein; and

FIGS. 7A to 7E illustrate a graphical representation of the first responder support system configured according to the disclosure provided herein.

### DETAILED DESCRIPTION OF THE INVENTION

The system, method and device disclosed herein provides for automatically generating a real-time emergency action plan and/or an interactive rescue plan accessible by first responders and site managers. The real-time action or rescue plan may provide a first responder with interactive site and surrounding information necessary for efficiently deploying resources to address an emergency. The real-time interactive rescue plan may include detailed information from a building information model, site and surrounding environment information, real-time traffic information, alarm and sensor information. The real-time interactive rescue plan may further cooperate with a rescue plan generator to provide a first responder with the tools to plan an ingress and egress from a site undergoing an emergency.

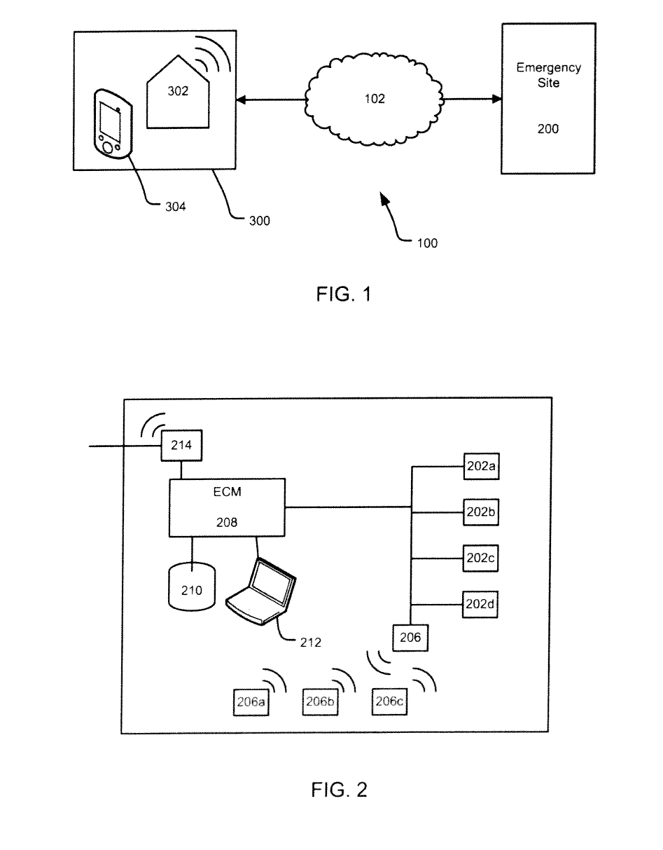

FIG. 1 illustrates an overview of an exemplary first responder support system 100 configured in accordance with the disclosure provided herein. The first responder support system 100 includes an emergency site 200 which may include one or more structures or buildings in a given geographic location. The first responder support system 100 further includes a first responder 300 in communication with the emergency site 200 via a communication network 102. The communication network 102 may be, for example, a cellular network, the Internet, a wide area network (WAN), a virtual private network (VPN), a wireless network or any combination thereof. The wireless network may operate according to a standardized communication protocol such as IEEE 802.11, 802.16, 802.20, 802.15.4 published by the Institute of Electrical and Electronic Engineers, or any other standardized protocol or standard.

As used herein the first responder 300 generally refers to both a first responder site or location 302 as well as a first responder device 304. The first responder site or location 302 may be, for example, a fire station in communication with the emergency site 200. Alternatively, the first responder location 302 could be a hospital, a police station, a governmental office, utility provider and/or any other entity charged with providing or supporting a first response. Moreover, as used herein the term first responder may refer to an individual utilizing the first responder device 304 or working at the first responder site or location 302. The first responder site 302 and/or the first responder device 304 may support both hardwired or wireless communication with the communication network 102 and the emergency site 200.

FIG. 2 illustrates a logical representation of the emergency site 200. The emergency site 200 in this example is a single building. As previously discussed, the emergency site 200 could encompass multiple buildings or structures in communication with each other at a single location or spread out among different geographic locations. The emergency site 200 may include multiple wired sensors 202a to 202d in communication with a building network 204. The building network 204 may further include a wireless controller or panel 206 in wireless communication with multiple wireless sensors 206a to 206c. The wired and/or wireless sensors may be temperature sensors, fire sensors, alarm pull stations, carbon monoxide sensors, door sensors, chemical sensors, motion and light sensors or any other known or contemplated building automation devices, components and sensors. Other building automation devices, components and sensors may be offered or provided by the Siemens Corporation® such as fire detection sensors. thermal and smoke detectors such as the VESDA air sampling system by Xtralis Pty. Ltd™, a series 3/X3 air duct detector and/or a linear beam smoke detector.

The emergency site 200 may further includes an emergency control module or unit 208. The emergency control module 208 may be a building or floor level controller that includes processing, information storage and communication capabilities necessary to support the first responder support system 100. For example, the emergency control module 208 may include a Pentium® class processor, RAM, ROM and a hard drive configured to store and implement an operating system, software programs, communication protocols or modules.

The emergency control module 208 may communicate with a storage device and/or database 210 and a terminal or personal computer 212. The storage device 210 may store and provide accessibility to a building information model (BIM) representative of the emergency site 200. A BIM includes building geometry, spatial relationships, geographic information, and quantities and properties of building components.

Building information modeling is the process by which a BIM is defined and covers or addresses the geometry, spatial relationships, light analysis, geographic information, quantities and properties of building components based on, for example, the manufacturers details. Systems, assemblies and sequences can be shown in a relative scale with the entire building or facility or group of buildings. Building information modeling requires adherence to interoperability standards developed for construction documents that include, but are not limited to, drawings, procurement details, environmental conditions, submittal processes and other specifications for building quality and operation. A BIM is often associated with one or more Industry Foundation Class (IFC) and aecXML (architecture, engineering and construction XML), which are data structures for representing information used in BIM. Other data structures are proprietary and may require conversion in order to ensure compatibility with the BIM. An exemplary BIM includes the information required to construct, assemble and render a detailed three-dimensional model of the emergency site 200.

The storage device 210 may further include or store both real-time and historical data received from the sensors 202a to 202d and 206a to 206c. The storage device 210 may be configured to provide the stored data to the emergency control module 208 and the personal computer 212. The personal computer 212 may be configured to access and manipulate the BIM. The personal computer 212 may further be configured to interact with the emergency control module 208 and a communications module 214. The communication module 214 provides access to the communication network 102 as well as the sensors deployed throughout the emergency site 200.

The personal computer 212 may be configured to provide facility manager the tools to create and manage an interactive emergency action plan (EAP) based on the received sensor data 202a to 202d and 206a to 206c and the BIM stored in storage device 210. The personal computer 212 may be configured to implement a modeling module to generate the BIM. The personal computer 212 and the modeling module may utilize static information and business rules stored in the storage device 210 to generate a basic EAP. For example, the static information may include exit information, fire extinguisher location information, sprinkler information, locations for first aid kits, hallway and stairwell widths, predefined locations of hazardous materials and occupancy information and/or estimates.

The personal computer 212 and the modeling module may further utilize real-time or dynamic information based on the received sensor data 202a to 202d and 206a to 206c and other alarm information. In this way, a basic EAP may be established to route occupants of the emergency site 200 to an exit based on factors such as shortest distance, proximity to a hazardous location, capacity and width of the hallways along the exit routes and any other quantifiable metrics. The modeling module and emergency control module 208 may further include real-time sensor data based on the indications provided by the sensors 202a to 202d and 206a to 206c. In this way, the personal computer 212 and modeling module may generate an interactive EAP that provides for adjusting the exit route based on the sensor or alarm information occurring along the planned route. Alternatively, the facility manager may adjust and interact with the route and the BIM to customize the EAP based on known conditions or factors within the emergency site 200.

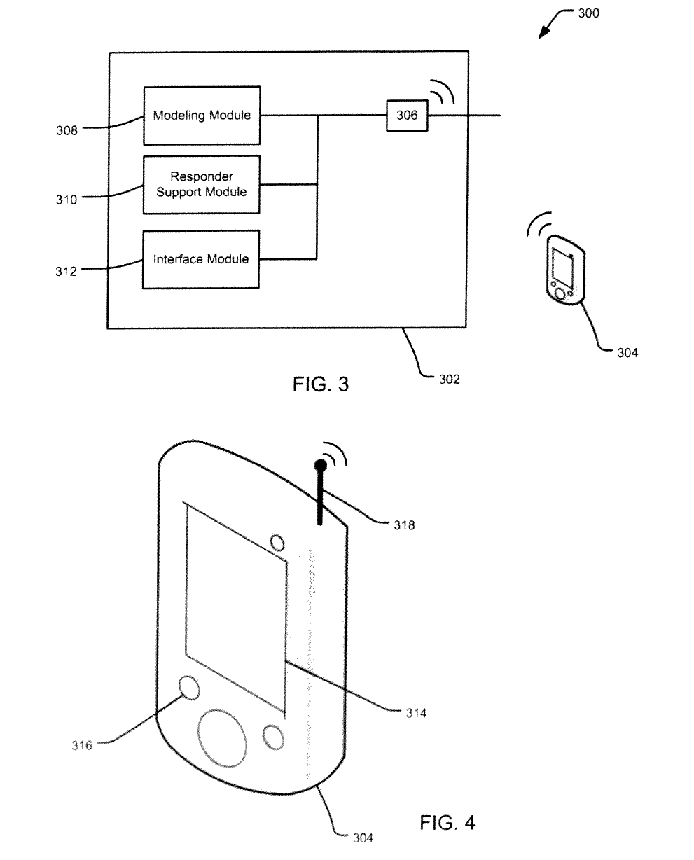

FIGS. 3 and 4 illustrate the exemplary first responder site or location 302 such as a fire station having hardware and software components or modules necessary to implement the first responder support system 100. The first responder site or location 302 may include a communication module 306 configured for and compatible with the communication network 102, the communication module 214 and the first responder device 304. The communication module 214 may further provide high-speed voice and/or data communication between the first responder site or location 302 and the first responder device 304.

In the event of an emergency at the emergency site 200, the facility manager may manually communicate an alert to the first responder site or location 302. Alternatively, the emergency control module 208 may automatically communicate an alert based on alarm information received from the sensors 202a to 202d and 206a to 206c. The alert, regardless of how activated, may trigger a data transfer between the emergency site 200 and the first responder site or location 302. For example, the static and real-time information stored within the storage device 210 may be automatically communicated to the communication module 306.

The received BIM and sensor information along with the basic and interactive EAP may, in turn, be communicated or provided to a modeling module 308 and a responder support module 310. The modeling module 308, as with the modeling module operable within the emergency control module 208, may be configured to generate an interactive BIM representative of the conditions known at the emergency site 200 at the time of transmission. Alternatively or in addition to, a dedicated communication channel may be established between the first responder 300 and the emergency site 200 to provide real-time or near real-time communication and updates from the sensors 202a to 202d and 206a to 206c.

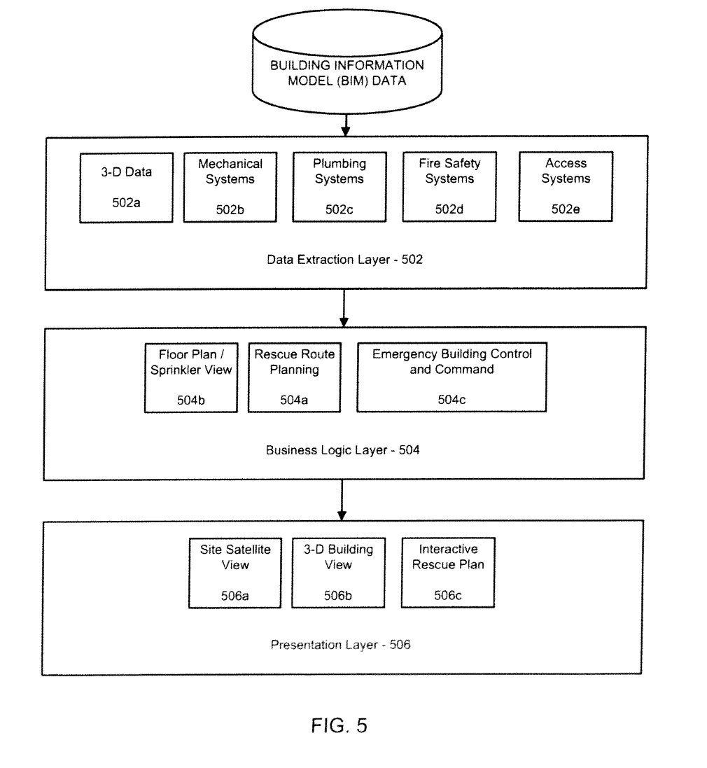

The interactive and updated BIM may be communicated to the responder support module 310 and a graphic user interface (GUI) 312 or interface module. The responder support module 310 may query and receive local traffic conditions information, meteorological information, satellite imagery, local maps and any other site or area information accessible via the communication module 306 and/or stored in the responder support module 310 and the storage device 210 (see FIG. 5). The combined area, site and conditions information can be converted and/or combined with the interactive BIM to create the basis for an interactive rescue plan.

FIG. 4 illustrates the first responder device 304 that may be utilized in connection with, and in replace of, the first responder site or location 302. For example, the first responder device 304 may include the processing and communications functionality provided by the first responder site or location 302. The first responder device 304 may be configured to receive, process and model BIM and sensor information from the emergency site 200. The first responder device 304 may further be configured to query and receive external area and site information necessary to produce and display an interactive rescue plan. In other embodiments, the interactive rescue plan may be generated at the first responder site or location 302 and communicated wirelessly to the first responder device 304 for modification, annotation and use.

The first responder device 304 includes a touchscreen display 314 configured to display the interactive rescue plan and BIM. The touchscreen display 314 may cooperate with user or interface controls 316 such as buttons, keys, a rollerball or toggle. In this way, a first responder or user may interact with a received or locally generated interactive rescue plan and BIM. Because the first responder device 304 is a portable device capable of wireless radio and cellular communication via an internally provided communication module 318, the interactive rescue plan can be altered and can evolve as the first responder's knowledge of a given emergency situation changes. The ability to dynamically interact with the interactive recue plan and BIM, provides first responders and other user to plan and deploy resources both within and around an emergency site.

FIG. 5 illustrates a logical view of an interactive rescue plan 500 that may be generated by the first responder support system 100. The interactive rescue plan 500 as disclosed in the present example includes, as previously discussed, the data and information associated with a BIM 502. The interactive rescue plan 500 employs a scalable layered architecture or layout that includes a data extraction layer 502, a business logic layer 504 and a presentation layer 506.

The data extraction layer 502 provides for extraction or parsing data from the building information model stored, for example, in the storage device 210. For example, the BIM data may be a structured data such as XML and may be extracted based on the meta-data resident in the XML format itself. The data extraction layer 502 may access BIM data necessary to generate a three dimensional (3-D) model 502a that includes building materials, building layout as well as ingress and egress points. The data extraction layer 502 may further include mechanical systems information 502b, plumbing system information 502c and fire safety information 502d. The mechanical systems information 502b, plumbing system information 502c and fire safety information 502d provide information regarding the systems and safety equipment deployed throughout the emergency site 200. The data extraction layer 502 may further include access control or security information 502e for controlling and monitoring access within the emergency site 200.

The business logic layer 504 may receive the parsed and processed data and information from the data extraction layer 502. In particular, the business logic layer 504 implements business rules or logic in connection with the received information. For example, the business logic layer 504 implements distance based rules in combination with traffic flow rules to generate and update an evacuation route 504a in connection with an interactive emergency action plan. Alternatively, the business logic layer 504 may generate integrated floor plan views 504b based on the received BIM data. The business logic layer 504 may further implement emergency control and emergency command and control functions 504c. The business logic layer 504 may further implement or provide for fire/smoke propagation modeling and/or filtering functionality to customize the information and view presented to the facility manager or first responder.

The presentation layer 506 incorporates data and information from both the data extraction layer 502 and the business logic layer 504. The presentation layer incorporates satellite imagery 506a and data to create a detailed site map. The presentation layer 506 may further include and provide a three-dimensional (3-D) model 506b of one or more buildings at the emergency site 200 as well as an interactive rescue plan 506c based on the received data. The presentation layer 506 may additionally provide and display both the basic evacuation route and/or an interactive evacuation route.

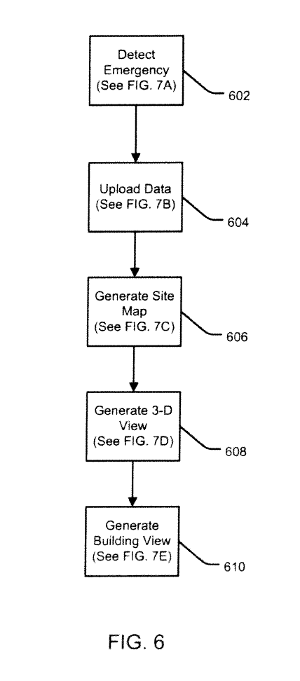

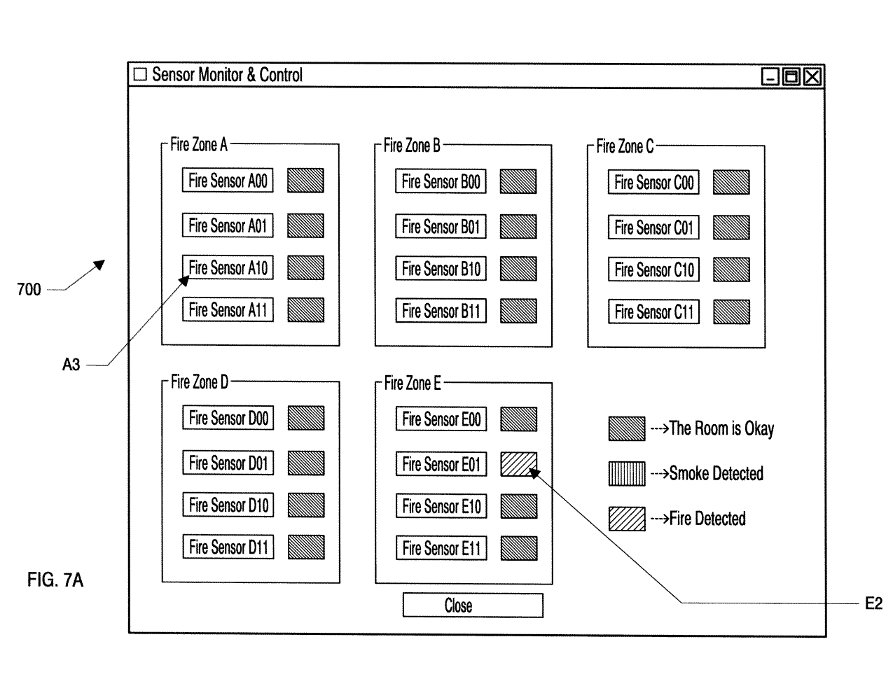

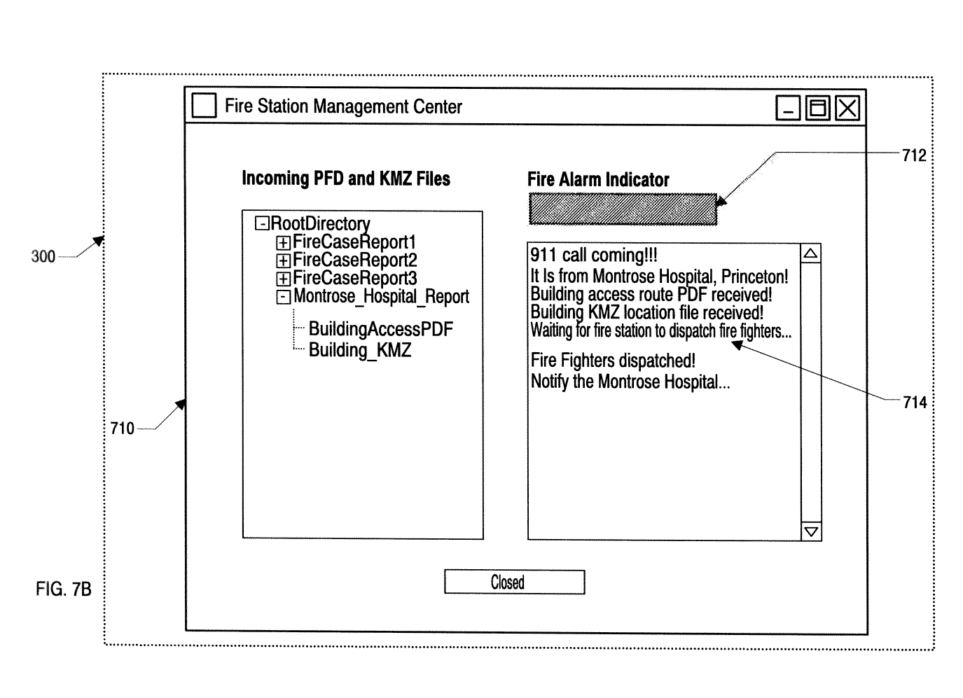

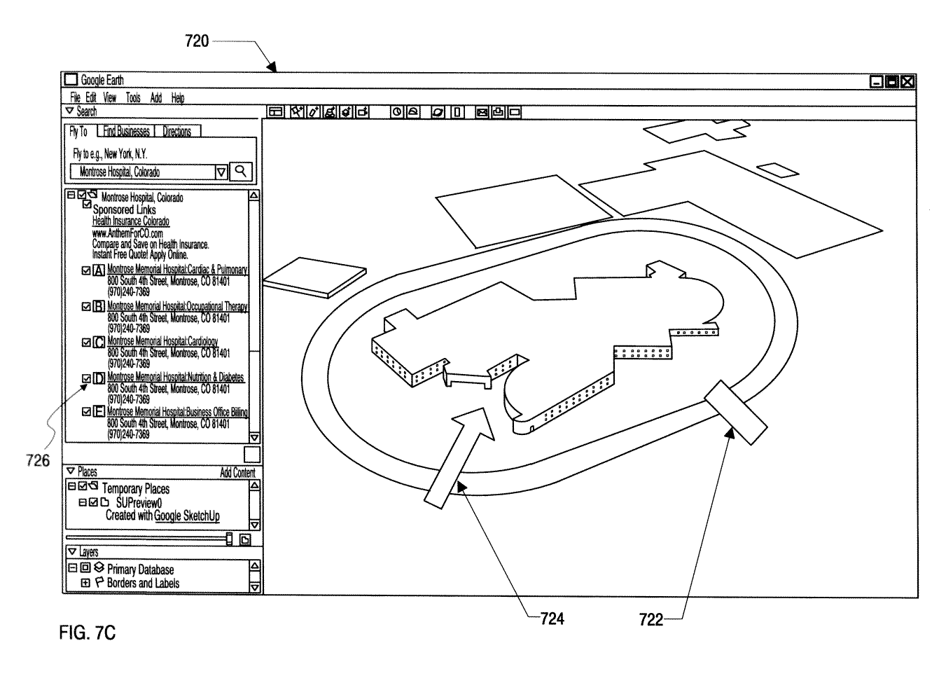

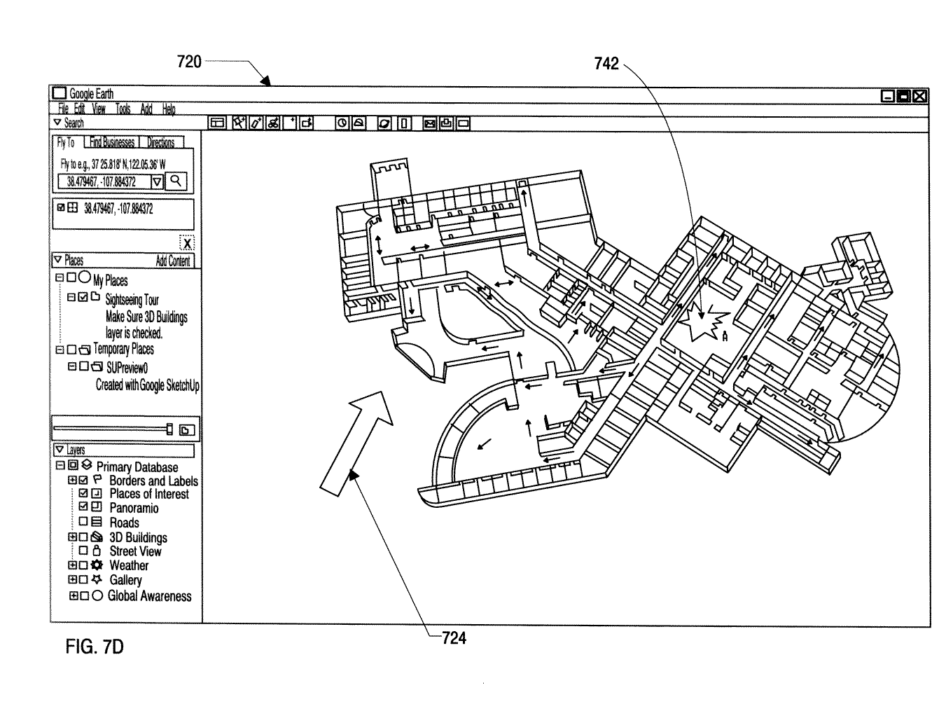

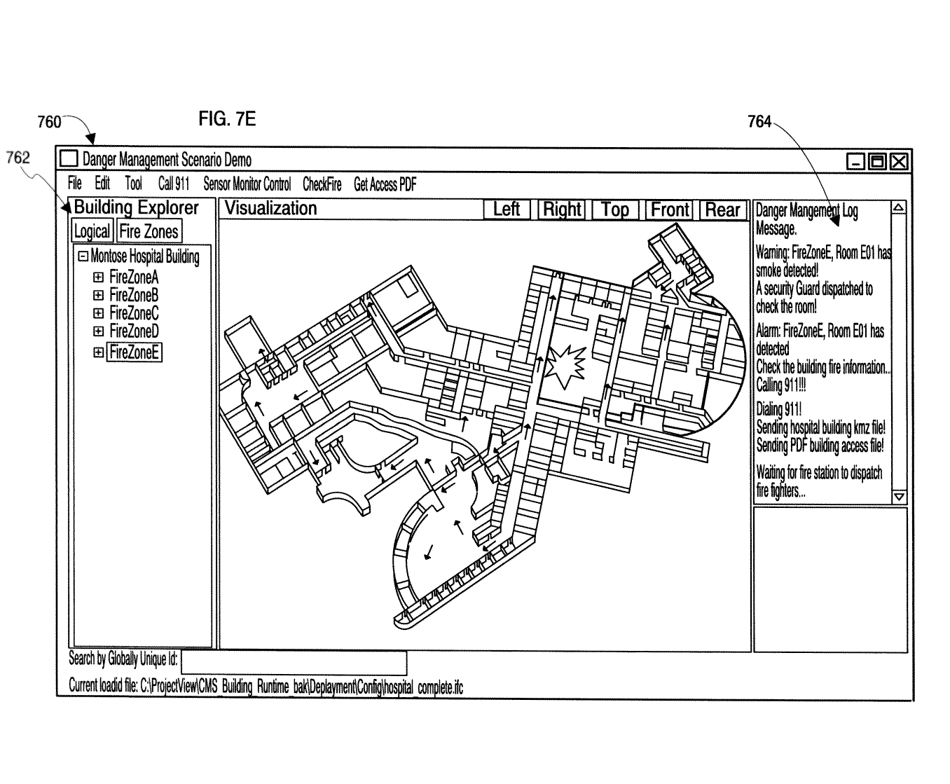

FIG. 6 and FIGS. 7A to 7E respectively illustrate a flowchart and corresponding screen shots that may be implemented and accessed as part of the first responder support system 100. At block 602, an emergency may be detected at the emergency site 200 and displayed at the sensor monitoring panel 700 shown in FIG. 7A. The exemplary sensor monitoring panel 700 illustrates alarm and/or sensor information in five (5) zones designated throughout the emergency site 200. Each of the zones A to E includes four sensors identified with a zone reference and a sensor number. For example sensor A3 identifies the third sensor in zone A. Upon detection of a sensor indication or alarm from sensor E2 in the exemplary embodiment, a previously defined emergency action plan (EAP) may be implemented. Depending on the routes defined in the EAP, the evacuation route 504a may be changed to guide building occupants away from the area or location corresponding to sensor E2. The detected sensor indication may automatically trigger an emergency or 911 call to the first responder 300 as well as a data upload of all associated BIM and sensor information. The upload may occur automatically or may be manually triggered by a facility manager of the emergency site 200

At block 604, the uploaded data including all associated BIM and sensor information may be received and displayed at a management station 710 (see FIG. 7B) deployed with the first responder 300. The uploaded data may include all BIM information necessary to construct a three-dimensional (3-D) model of the emergency site 200. The uploaded data may further include satellite and other file data necessary to provide a site image. For example, the uploaded data may be provided, at least in part, in a file format compatible with Google Earth® in order to provide satellite images of the emergency site and surrounding environs. The management station 710 provides an alarm indication 712 as well as site and communication status information and updates 714.

At block 606, the uploaded BIM, sensor and site information may be processed to provide a site made 720 shown in FIG. 7C. The site map 720 may allow the first responder 300 to identify, for example, a site for a roadblock 722 and a point of entry 724. This information may be communicated to other first responders utilizing the same system to allow for a coordinated deployment of resources. The site map 720 may further include additional information 726 regarding the surrounding area of the emergency site 200.

At block 608, the site map 720 may be expanded and/or the view may be changed to visually incorporate the BIM data and generate a 3-D view 740 of the emergency site 200 as shown in FIG. 7D. In this exemplary 3-D view 740, the point of entry 724 is shown with relation to the emergency 742. As will be understood from the previous example, the emergency site 742 corresponds to sensor E2 in zone E. The first responder 200 may adjust the EAP to route people away from the emergency site 742 while at the same time providing or clearing a route to allow other first responders to access the incident area.

At block 610, the 3-D view 740 may be adjusted to provide a building view 760 shown in FIG. 7E. In particular, the satellite and/or additional location information may be suppressed and a building explorer 762 provided to access and highlight the individual zones A to E within the emergency site 200. The building view 760 may further provide updated sensor and alarm information 764.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A first responder support system comprises:
a plurality of sensors deployed within a building, wherein each of the plurality of sensors is configured to communicate an environmental condition;
an emergency control module in communication with the plurality of sensors deployed within the building, wherein the emergency control module is configured to receive the environmental conditions provide by the plurality of sensors;
a modeling module configured to receive a building information model and to generate a building representation; and
a responder support module in communication with the emergency control module and the modeling module and configured to generate an interactive rescue plan based on the building representation and the received environmental conditions.

2. The system of claim 1, wherein the plurality of sensors and the emergency control module are deployed at a first location, and wherein the responder support module is deployed at a second location which is different than the first location.

3. The system of claim 2 further comprising a communications module configured to communicatively couple the first location to the second location.

4. The system of claim 1, wherein the environmental conditions are real-time environmental conditions.

5. The system of claim 1 further comprising a site environment module configured to provide geographic information related to the building.

6. The system of claim 1, wherein the plurality of sensors contains at least one sensor selected from the group consisting of: a smoke detector, a carbon monoxide detector, an emergency door sensor, a temperature sensor, an airflow sensor, heating, ventilation and air conditioning (HVAC) sensors, a motion sensor, and fire alarm pull sensors.

7. A method for generating an interactive rescue plan, the method comprising:
deploying a plurality of sensors within a building at a first location;
receiving a sensed environmental condition for at least one of the plurality of sensors;
triggering an emergency alert in response to the received sensed environmental condition;
communicating the received sensed environmental condition and a building information model to a second location;
receiving the received sensed environmental condition and the building information model at a modeling module deployed at a second location;
generating an interactive building representation based on the received sensed environmental condition and the building information model; and
generating an interactive rescue plan based on the interactive building representation and one or more business rules.

8. The method of claim 7, wherein the received sensed environmental condition and the building information model are received at a portable device in wireless communication with the building.

9. The method of claim 7, wherein generating an interactive building representation further includes generating an interactive site representation.

10. The method of claim 7 further comprising generating a real-time evacuation plan based on the received sensed environmental condition and the building information model.

11. The method of claim 7, wherein the environmental condition is a real-time environmental condition.

12. The method of claim 7 further comprising updating the interactive rescue plan based on a change in the real-time environmental condition.

13. A first responder support device comprises:
a communication module configured to receive at least one environmental condition from a plurality of sensors deployed within a building, wherein the building, wherein each of the plurality of sensors is configured to communicate an environmental condition;
a modeling module configured to receive, via the communication module, a building information model and to generate a building representation;
a responder support module in communication with the communication module and the modeling module and configured to generate an interactive rescue plan based on the building representation and the received environmental conditions; and
an interface module configured to present the interactive rescue plan.

14. The device of claim 13, wherein the environmental condition is communicated to the communication module from an emergency control module deployed within the building.

15. The device of claim 13, wherein the communication module includes a cellular radio module and a network communication module.

16. The device of claim 15, wherein the network communication module is configured to provide a wireless network connection and a wired network connection.

17. The device of claim 13, wherein the interface module include a touchscreen.
